(19) United States
(12) Patent Application Publication
(10) Pub. No.: US 2005/0276949 A1
(43) Pub. Date: Dec. 15, 2005

(54) Optical film and method of manufacture

(75) Inventors: Robert P. Bourdelais, Pittsford, NY (US); Cheryl J. Brickey, Webster, NY (US); John E. Benson, Webster, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/868,689

(22) Filed: Jun. 15, 2004

(51) Int. Cl. B32B 5/16; B32B 31/30

(52) U.S. Cl. 428/141; 428/323; 156/247; 156/244.11

(57) ABSTRACT

A method of forming an element of an imaging device includes providing a first layer and a second layer. The method also includes extruding the first layer with the second layer, where the first layer has a melt viscosity at a point of extrusion that is greater than a melt viscosity at the point of extrusion of the second layer. Moreover, the method includes forming a plurality of optical elements over a surface of the second layer.

### CROSS-REFERENCE TO RELATED APPLICATIONS

The present application is related to U.S. patent application Ser. No. (Kodak Attorney Docket 88182) entitled “THERMOPLASTIC OPTICAL FEATURE WITH HIGH APEX SHARPNESS” to Brickey, et al. This application is being filed concurrently, and the disclosure of this application is specifically incorporated herein by reference.

### TECHNICAL FIELD

The embodiments described relate generally to elements of an imaging system, and more particularly to components that improve light efficiency in light valve imaging devices.

### BACKGROUND

Light-valves are implemented in a wide variety of display technologies. For example, display panels are gaining in popularity in many applications such as televisions, computer monitors, point of sale displays, personal digital assistants and electronic cinema to mention only a few applications.

Many light valves are based on liquid crystal (LC) technologies. Some of the LC technologies are prefaced on transmittance of the light through the LC device (panel), while others are prefaced on the light traversing the panel twice, after being reflected at a far surface of the panel.

The LC material is used to selectively rotate the axes of the liquid crystal molecules. As is well known, by application of a voltage across the LC panel, the direction of the LC molecules can be controlled and the state of polarization of the reflected light selectively changed. As such, by selective switching of the transistors in the array, the LC medium can be used to modulate the light with image information. This modulation may be used to provide dark-state light at certain picture elements (pixels) and bright-state light at others, where the polarization state governs the state of the light. Thereby, an image is created on a screen by the selective polarization transformation by the LC panel and optics to form the image or ‘picture.’

In many LCD systems, the light from a source is selectively polarized in a particular orientation prior to being incident on the LC layer. The LC layer may have a voltage selectively applied to orient the molecules of the material in a certain manner. The polarization of the light that is incident on the LC layer is then selectively altered upon traversing through the LC layer. Light in one linear polarization state is transmitted by a polarizer (often referred to as an analyzer) as the bright state light; while light of an orthogonal polarization state is reflected or absorbed by the analyzer as the dark-state light.

While LCD devices are becoming ubiquitous in display and microdisplay applications, there are certain drawbacks associated with known devices, their components and methods of manufacture. For example, in known structures the efficiency of light transmission to the final imaging surface is rather poor, and results in poor image quality.

What is needed therefore is a method and apparatus that overcomes at least the shortcomings of the known devices described above.

### SUMMARY

According to an example embodiment, a method of fabricating elements of an imaging device includes providing a first layer and a second layer; extruding the first layer; a plurality of optical elements over an upper surface of the first layer and a substantially smooth surface on a lower surface of the first layer. The second layer comprises a compliant layer having at least one void.

According to another example embodiment, a component of an imaging device includes a first layer having an upper surface over which a plurality of optical elements are disposed and a lower surface that is substantially smooth. The component also includes a second layer that is disposed over a lower surface of the first layer. This second layer comprises a compliant layer, having at least one void.

### BRIEF DESCRIPTION OF THE DRAWINGS

The invention is best understood from the following detailed description when read with the accompanying drawing figures. It is emphasized that the various features are not necessarily drawn to scale. In fact, the relative dimensions may be arbitrarily increased or decreased for clarity of discussion.

FIG. 1 is a cross-sectional view of an LCD including a backlight assembly in accordance with an illustrative embodiment.

FIG. 2 is perspective view of a light redirecting element in accordance with an example embodiment.

FIG. 3 is a cross-sectional view of a light redirecting layer in accordance with an embodiment.

FIG. 4 is a perspective view of a light redirecting layer in accordance with an example embodiment.

FIG. 5 is a cross-sectional schematic view of an apparatus for forming a collimation layer in accordance with an example embodiment.

### DETAILED DESCRIPTION OF THE INVENTION

In the following detailed description, for purposes of explanation and not limitation, example embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known apparati and methods may be omitted so as to not obscure the description of the present invention. Such methods and apparati and methods are clearly within the contemplation of the inventors in carrying out the example embodiments. Wherever possible, like numerals refer to like features throughout.

Briefly, and as described in connection with example embodiments herein, a light redirecting layer has a first layer and a second layer. The first layer includes a lower surface that is smooth, and thereby does not significantly frustrate the recycling by diffusing the light. The first layer also has an upper surface from which a plurality of optical elements is formed. Over the lower surface of the first layer, a second layer is disposed. The second layer comprises a compliant layer that may be separated from the first layer after fabrication. As will become clearer as the present description continues, among other benefits, the second layer allows the optical elements to be fabricated in a substantially uniform manner across the surface of the light redirecting layer, and with certain beneficial optical properties as well. Moreover, the second layer is of a material that fosters the forming of a smooth lower surface on the first layer.

The light redirecting layers of the illustrative embodiments are typically substantially transparent optical films or substrates that redistribute the light passing through the films such that the distribution of the light exiting the films is directed more normal to the surface of the films. Typically, light redirecting films are provided with prismatic grooves, lenticular grooves, or pyramids on the light exit surface of the films. These grooves or pyramids change the angle of the film/air interface for light rays exiting the films and caused the components of the incident light distribution traveling in a plane perpendicular to the refracting surfaces of the grooves to be redistributed in a direction more normal to the surface of the films compared to light entering the films. Such light redirection layers may be used, for example, with liquid crystal displays, in laptop computers, word processors, avionic displays, cell phones, PDAs, and the like, to make the images brighter and of higher contrast. Finally, it is noted that while the illustrative embodiments describe the features and fabrication of a light redirecting layer, it is emphasized that this is merely illustrative. In fact, many other types of optical elements could be fabricated by the illustrative methods and from materials described. These include, but are not limited to focusing and diffusing elements.

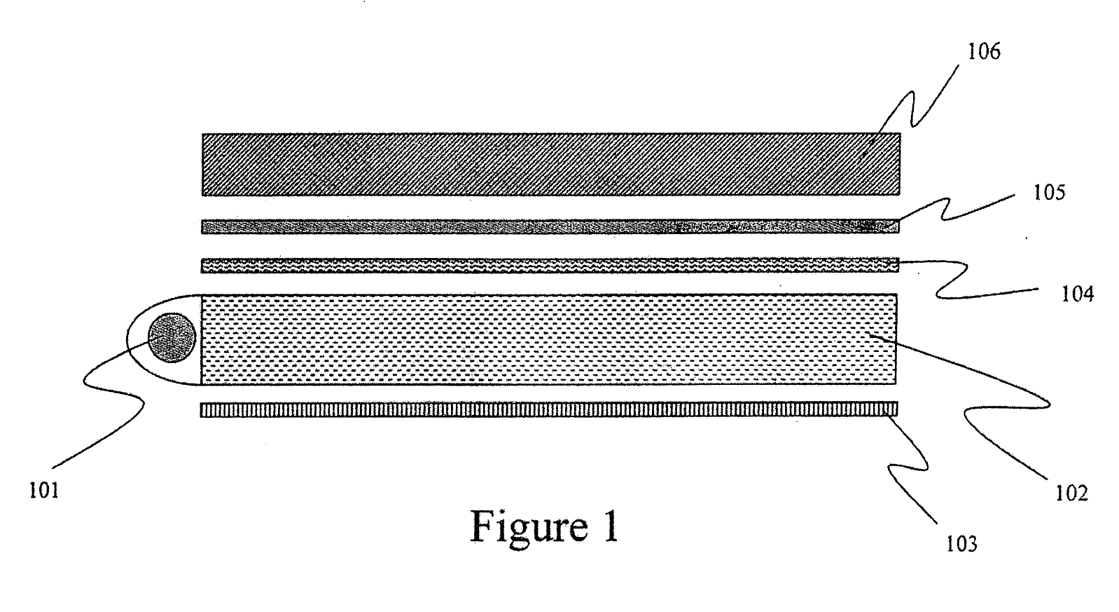

FIG. 1 shows an imaging device 100 in accordance with an illustrative embodiment. The imaging device includes an extruded light redirecting polymeric layer 105 fabricated by a method of an example embodiment described herein. In the present embodiment, a light source 101 couples light to a light guide 102, which includes a diffusively reflective layer 103 disposed over at least one side as shown. The light source 101 is typically a cold cathode fluorescent bulb (CCFB), ultra-high pressure (UHP) gas lamp, light emitting diode (LED) array, or organic LED array. It is noted that this is merely illustrative and other sources suitable for providing light in a display device may be used.

Light from the light guide 102 is transmitted to an optional diffuser 104 that serves to diffuse the light, beneficially providing a more uniform illumination across the display (not shown), hide any features that are sometimes printed onto or embossed into the light guide, and reduce moire interference. As described in further detail herein, after the light passes through the light redirecting film 105, it emerges as a narrower cone compared to the light entering the film. The light redirecting layer 105 illustratively is oriented so the individual optical elements are on a side that is closer to an LC panel 106.

Between the light redirecting layer 105 and the LC panel 106, other devices may be disposed such as another diffuser or a reflective polarizer (not shown). Moreover, another polarizer (often referred to as an analyzer) may be included in the structure of the LC display 100. As many of the devices of the display 100 are well-known to one of ordinary skill in the art of LC displays many details are omitted so as to not obscure the description of the example embodiments.

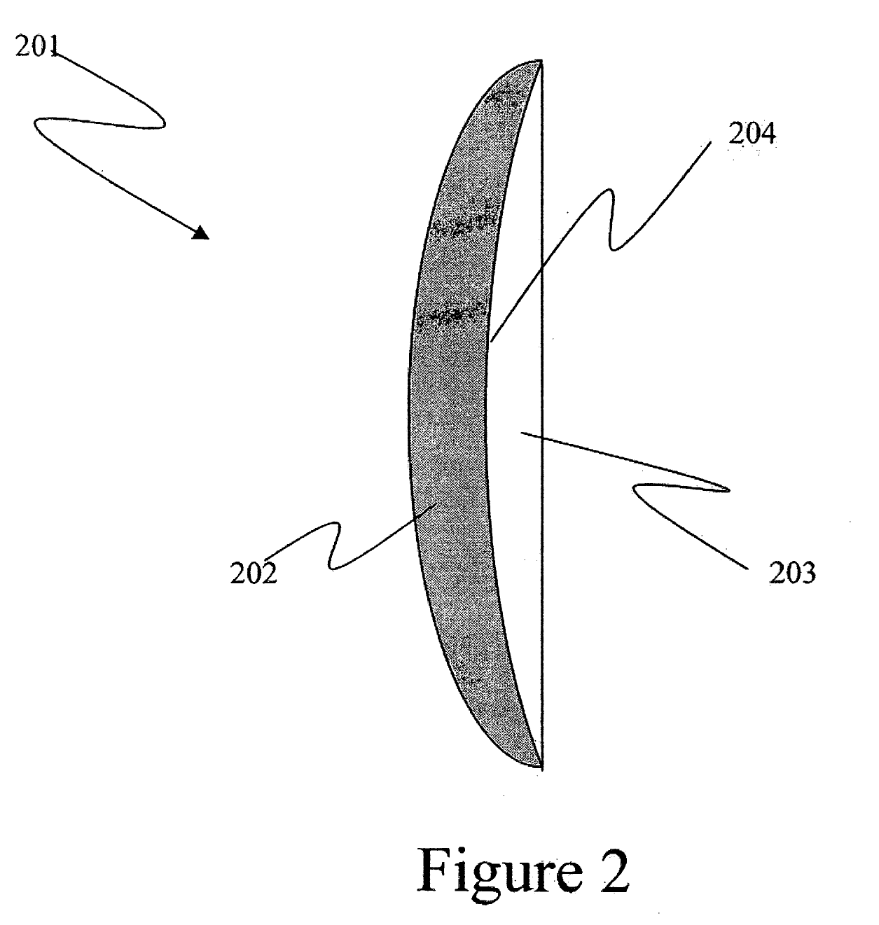

FIG. 2 is a perspective view of an optical element 201, which would be disposed at a top surface of the light redirecting layer (e.g., layer 105) according to an example embodiment. Of course, this is but one of a plurality of similar elements of the light redirecting layer. In the example embodiment, the element 201 is a curved wedge shape having a curved surface 202 and a planar surface 203. The curved surface 202 can have curvature in one, two, or three axes and serves to redirect the light one or more directions, as described more fully herein. The two surfaces 202 and 203 meet at a ridge 204. Illustratively, the ridge 204 is the linear apex formed where the surfaces 202 and 203 of the element 201 meet.

It is noted that the shape of the element 201 is illustrative, and that elements of other shapes than the curved wedge shape can be used. Beneficially, the elements having different shapes than those of FIG. 2 include the useful aspects of the apex and sides 202, 203 for light redirecting light and recycling light that would otherwise be lost as described in connection with certain illustrative embodiments. Of course, in order to realize the structures having the reduced land area and the substantial uniformity, it is useful to provide a skin layer as described herein.

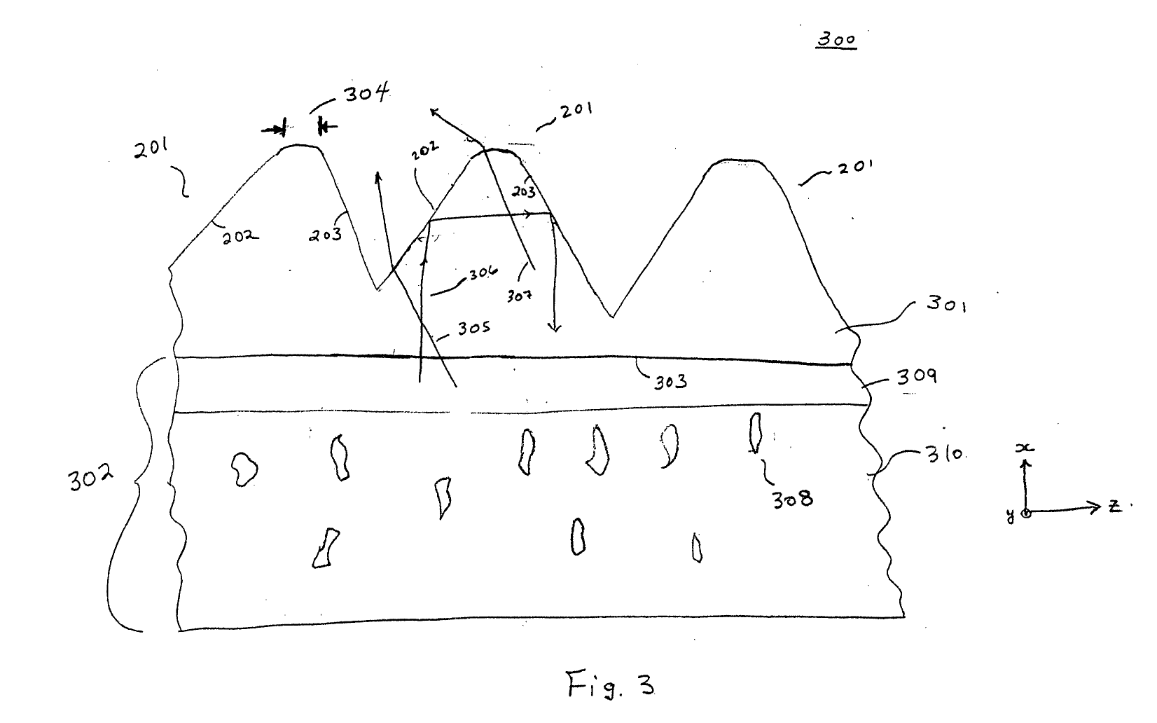

FIG. 3 is a cross-sectional view of a light-light redirecting component 300 in accordance with an illustrative embodiment. The light redirecting component 300 includes a plurality of optical elements 201. As will become clearer as the present description continues, the optical elements are formed of a first layer 301, which is formed over a second layer 302. The first layer 301 has optical properties that are beneficial to the component 300; and the second layer 302 provides a cushioning or compliance during fabrication. This cushioning fosters the fabrication of the various features of the optical elements 201 with a reduced pressure, which results in a substantially smooth lower surface 303 of the first layer 301. These fabrication techniques are described in conjunction with example embodiments described herein. Finally, it is noted that the second layer 302 may be removed prior to implementation of the first layer 301 in an imaging device.

The surfaces 202 and 203 beneficially provide an approximately 45° interface with the surrounding medium. Of course, it is noted that this is not essential, and the interface may be other than 45°. Moreover, it is beneficial that the features of the element have a cross section indicating a 90° included angle at the highest point (apex) of the feature. It is noted that in the likely case that the apex has a width or land 304 at the highest point, this included angle is measured at the intersection of the projection of the sides.

In an illustrative embodiment, a 90° peak angle is beneficial because it produces the highest on-axis brightness for the light redirecting film. It is noted that an angle of approximately 88° to 92° produces similar results and can be used with little to no loss in on-axis brightness. Further, when the angle of the apex is less than approximately 85° or greater than approximately 95°, the on-axis brightness for the light redirecting film decreases.

As alluded to above, one benefit of the structure of the elements 201 are their ability to substantially redirect light that has a relatively high angle relative to the center axis or viewing axis (perpendicular to the plane of the film); and to recycle the light that has a relatively low angle relative to the axis. To this end, light 305, which is incident to surface 202 at a relatively low angle is refracted at side 202 toward the viewing axis and is provided to the LC panel 106 in a direction closer to the normal of the film. However, light 306, which is incident to surface 202 at a relatively high angle, is reflected and ultimately returned toward the light guide 103. Ultimately, a portion of this light 306 will be again incident on the element 101 or its diffusive reflector 103, and may then be recycled as diffuse light that improves the efficiency and thus the performance of the imaging device 100.

As can be readily appreciated, but for the element 201, light 305 would be so far off the viewing axis, as to not benefit the on-axis viewing of the LC display. To wit, light 305, if not reflected as shown, would be well outside the acceptance of the LC panel 106, or the other elements of the imaging display. This loss of light will deleteriously impact the light efficiency from the light source 101 to the imaging surface (not shown). Ultimately, this will adversely impact the quality of the image, particularly when viewed nearly on-axis.

In addition to the beneficial characteristics of the geometric relationship of the sides 202 and 203 of the element 201, the width or land 304 of the apex also impacts the efficiency of light transmitted from the light source 101 to the LC panel 106, and thus affects the quality of the image provided by the imaging system. To this end, the width 304 of the apex is ideally nullity: a point formed by the convergence of the two sides 202 and 203. In this case, the light incident within the range of incidence referenced will be refracted and emerge in a more substantially normal direction to the film no matter the exact point of incidence on the element 201.

However, by known methods there are manufacturing limitations that often prevent a true point. Rather, a land 304 that is flat or rounded may result. Such a land has substantially no optical impact on light incident thereon. For example, light 307 is lost due to the lack of refraction at the land 304. Thus, it is advantageous to minimize the width 304 as much as possible. Stated a bit differently, it is beneficial to minimize the contribution of the apex to the surface area of the element 201. The greater the portion of surface area from the apex, the less effective the element 201 is at light redirecting.

Moreover, it is useful to maintain the uniformity of the magnitude of the width 304 across the layer 301 comprised of a plurality of elements to less than a certain deviation. This uniformity is beneficial to the quality of the image because of the exceptional ability of the human eye to detect differences of greater than approximately 0.75 μm. In accordance with an illustrative embodiment, the width or land 304 has a magnitude of approximately 0.25 μm to approximately 0.75 μm, and a deviation of approximately ±0.5 μm across a layer comprised of a plurality of elements. It is noted that the dimensions provided are merely illustrative. For example, the width 304 may be approximately 0.20 μm, if not smaller. Moreover, the width 304 may be greater than 0.75 μm; however, as the width approaches 3.0 μm, the effectiveness of the redirection properties of the element 201 is substantially lost. Finally, as will become clearer as the present description continues, the dimensions, angular orientations and tolerances are effected in accordance with fabrication methods of example embodiments.

The layer 302 is illustratively comprised of compliant layer 310 and a smoothing layer 309. The layer 310 is a substantially compliant due at least partially to the presence of voids 308, which provide a fluid-like reaction to forces applied to the layer 302.

In an example embodiment the compliant layer has a modulus of elasticity of approximately 2500 MPa, and is beneficial to the formation of the optical elements 201 with high quality features and at relatively low and uniform forming pressure. The smoothing layer 309 is more rigid than the compliant layer 310 and provides smoothness to the lower surface 303 of the layer 301. The details of these voids 308, the compliance of layer 310 and the use of the smoothing layer 309 to effect a desirably smooth surface 303 are described more fully herein.

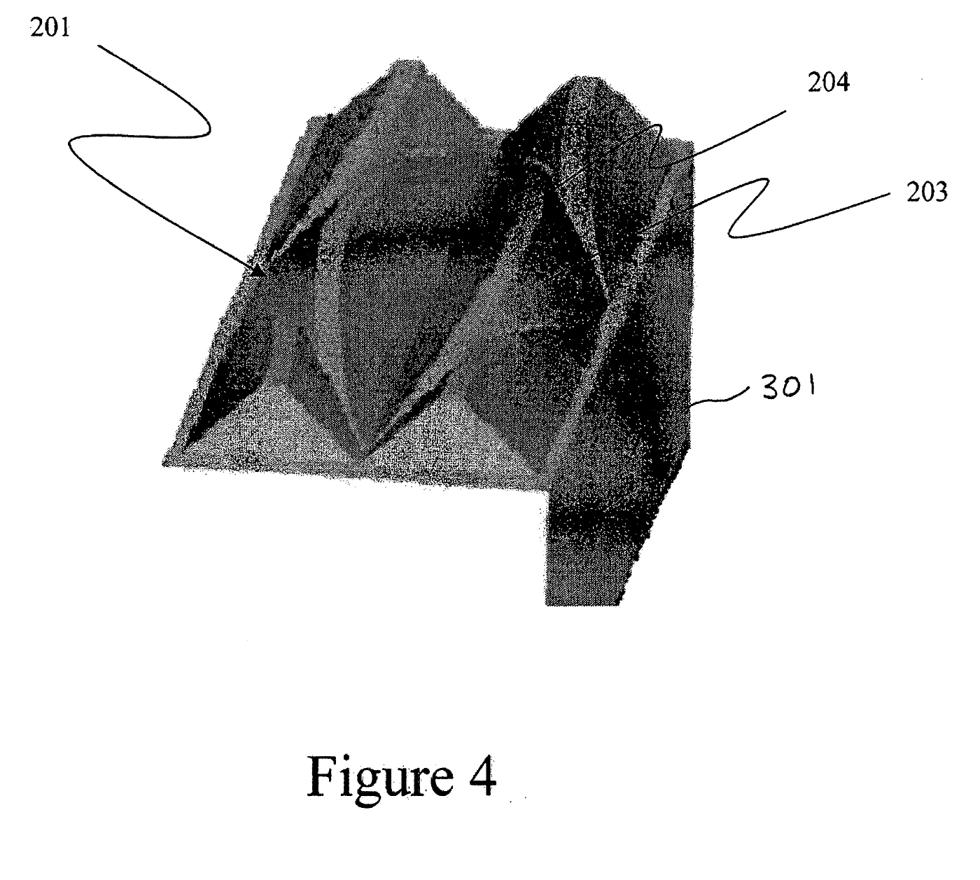

FIG. 4 is a perspective view of a portion of a light redirecting component 300 in accordance with an example embodiment. The light redirecting component 300 includes a plurality of elements 201 described in connection with the example embodiments of FIGS. 2 and 3. It is noted that the orientation of the element 201 may be regular or random. These and other details may be found in the reference to Brickey, et al., described above.

In the example embodiments of FIGS. 2-4, elements 201 are a curved wedge shaped elements and are randomly placed and parallel to each other. This causes the ridges 204 to be generally aligned in the same direction. To this end, it is beneficial to have the ridges generally aligned so that the layer redirects light in substantially one direction (e.g., the axis of an image plane) thereby creating higher on-axis gain in a liquid crystal backlight structure of an illustrative embodiment. Alternatively, the surfaces 202, 203 have a certain curvature. This curvature can be in the plane of the component 300, perpendicular to the plane of the component 300, or both. Thus, it may useful to have elements 201 with curvature in the plane of the film such that the elements can redirect light in more than one direction

As can be readily appreciated, the curvature of the ridge 204 is a smooth arcuate curve, such as a part of a circle or an ellipse. The radius of curvature is illustratively a segment of a circle. The radius of curvature determines how much light is redirected in each direction and how much moire and on-axis brightness the film will have. Additionally, the wedge shaped elements 201 on the light redirecting component 300 have pitch or angular orientation that are varied relative to the dimensions, pitch or angular orientation of the pixels or other repeating elements such that moire interference patterns are not visible through the LCD panel.

In an illustrative embodiment, the optical elements 201 are randomly oriented relative to one another to reduce or significantly eliminate any interference with the pixel spacing of a liquid crystal display. This ‘randomization’ can include the size, shape, position, depth, angle or density of the optical elements. This may eliminate the need for diffuser layers to defeat moire and similar effects. Also, at least some of the individual optical elements may be arranged in groupings across the exit surface of the films, with at least some of the optical elements in each of the groupings having a different size or shape characteristic that collectively produce an average size or shape characteristic for each of the groupings that varies across the films to obtain average characteristic values beyond machining tolerances for any single optical element and to defeat moire and interference effects with the pixel spacing of a liquid crystal display. In addition, at least some of the individual optical elements may be oriented at different angles relative to each other for customizing the ability of the films to reorient/redirect light along two different axes. It is important to the gain performance of the films to avoid planar, unfaceted surface areas when randomizing features.

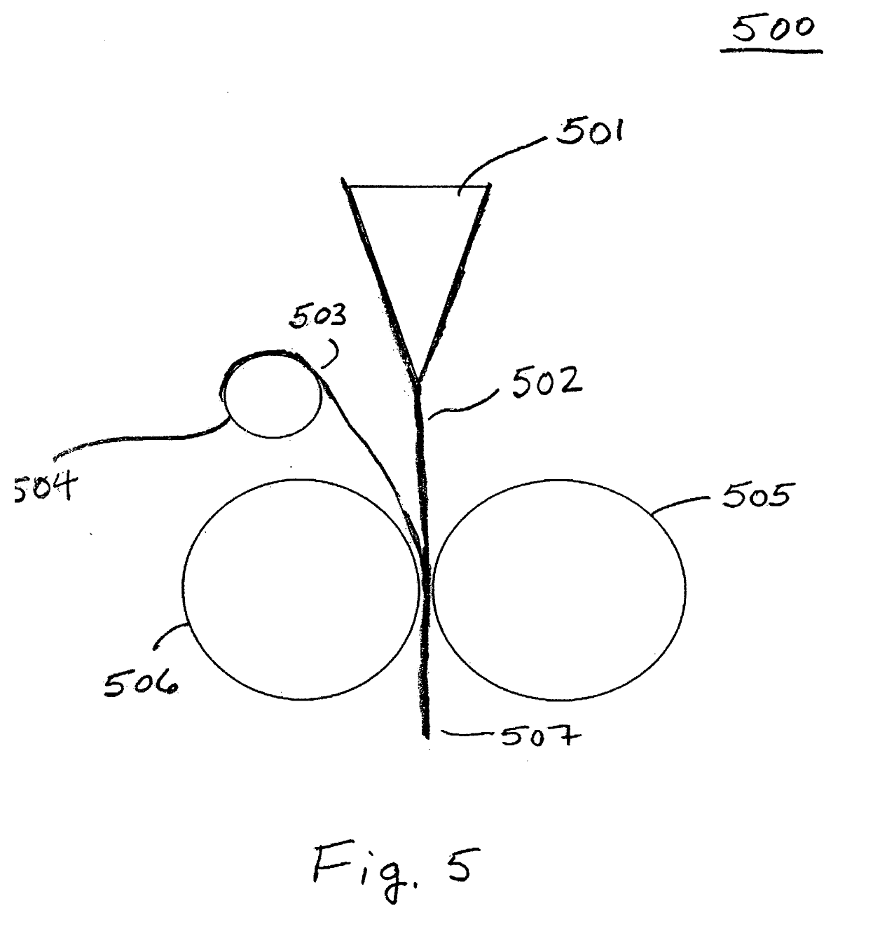

FIG. 5 is a cross-sectional schematic view of a fabrication apparatus 500 used for forming a light redirecting layer in accordance with example embodiments. The apparatus and methods may be used to fabricate the light redirecting layer and the optical elements of the example embodiments of FIGS. 2-4 with the beneficial features described above.

The apparatus 500 includes an extruder 501 through which a first material 502 is extruded. A second material 503 is provided via a roller 504. The first material 502 (also referred to as a melt) and the second material 503 (also referred to as a carrier web) are introduced between a first roller 505 and a second roller 506. As will become clearer as the present description continues, the first material 502 has a top surface in contact with the first roller 505 and the second material 503 has a bottom surface that is in contact with the second roller 506. The rollers exert pressure upon the materials 502 and 503 as described herein.

In accordance with an example embodiment, as the first material 502 is pressed through the rollers 505, 506 an optical layer is formed having a plurality of optical elements disposed over at least one surface. For example, the processes of the example embodiments described in connection with FIG. 5 may be used to fabricate the light redirecting component 300 with the first material 502 forming the layer 301 and the second material 503 forming the layer 302, illustratively comprised of layers 309 and 310.

The first roller 505 is in contact with the first material 502 and forms the patterned surface (not shown in FIG. 5) that forms the pattern of the plurality of elements 201 of the illustrative embodiments. The second roller 506 is in contact with the second material 503, which comprises a compliant layer (e.g., compliant layer 310). The pressing action of the rollers on the compliant layer effects a uniform disposition of pressure from the compliant layer to the first material, resulting in a uniform patterning of the elements with the desired structure. Moreover, because of the compliance of the second material 503, the pattern is formed at a reduced pressure compared to known methods. As such, uniformity and quality in the pattern are affected at lower fabrication pressures compared to known methods. Finally, the second material 503 may also comprise a smoothing layer (e.g., layer 309), which beneficially provides smoothness to the lower surface (e.g., surface 303) of the formed layer. This smoothness is useful in many optical applications of the layer, as referenced previously.

After passing through the rollers 505, 506, a layer 507 is formed. This layer 507 includes the features of component 300 of the illustrative embodiment, and may be used as a light redirecting layer. It is noted that the second material 503 may be removed from layer 507 prior to implementation in an imaging device.

The first material 502 is illustratively a material that has a variety of desirable properties from both from the perspective of manufacturing and optical performance. For example, the first layer 301 is substantially transparent; provides UV stability; has an acceptable hardness for display applications; has a relatively high mechanical modulus; and can be an extruded monolayer or multilayer.

In an illustrative embodiment, the first material 502 is a polycarbonate material that has high optical transmission (i.e., highly transparent) and is durable. Polycarbonates are available in grades for different applications and some are formulated for high temperature resistance, excellent dimensional stability, increased environmental stability, and lower melt viscosities.

Thermoplastics are useful because they are inexpensive and readily processed. UV cured materials sometimes suffer from lower environmental stability and need to be coated onto a preformed substrate. In addition to the complexity of manufacture, UV coatings are susceptible to curling and other deleterious aspects.

Illustrative polymers for the second material 503 include polyester (such as PET and PEN), oriented PET or PEN, oriented polyolefin such as polyethylene and polypropylene, cast polyolefins such as polypropylene and polyethylene, polystyrene, acetate, polycarbonate and vinyl.

The use of an oriented material for material 503, such as oriented PET is beneficial to the extrusion process for a number of reasons. To wit, the material 503 is compliant and thus assists in the beneficial application of uniform pressure. Moreover, the second material 503 may include a layer that is exceedingly smooth. Illustratively, the second material 503 includes the compliant layer 310 and the smoothing layer 309. The smoothing layer 309 is beneficial in the forming of a substantially smooth surface 303, which has a surface smoothness (roughness average or Ra) on the order of approximately 200 nm. Notably, the roughness average may be approximately 40 nm to approximately 15 nm. Furthermore, the material 503 has a relatively high transition temperature, which enables its use in higher temperature applications. Illustratively, at least the portion of the material 503 that corresponds to the compliant layer 310 has a glass transition temperature (T_{g}) in the range of approximately 120° C. to 300° C.

In an example embodiment, the second material 503 including the smoothing layer 309 is drawn through the rollers 505 and 506, resulting in the highly smooth surface 303. In order to affect this desired result, the smoothing layer 309 is compliant than the compliant layer 310 and has a lower surface roughness (Ra) than what is desired for the smooth surface of the first layer 301. Further, according to an illustrative embodiment, oriented at least partially crystalline polymers having surface roughness less than 200 nm are used to provide a smooth surface on the lower surface 303 of the first layer 301.

It is noted that other materials, often materials having a crystalline orientation such as oriented polyester, having the desired properties of compliance, smoothness and heat tolerance may be used as material 503. Some of these materials are specifically mentioned, while others, within the purview of one of ordinary skill in the art having the benefit of the present disclosure, may be used in this capacity.

As stated, the second material 503 forms the second layer of the layer 302, and the second material 503 is chosen for its compliance during the rolling process. To this end, when the first material 502 is extruded through rollers 505 and 506, it is beneficial to provide uniform pressure over its surface. If uniform pressure is not applied, pressure profiles may result, and can have a deleterious impact on the overall structure of the layer 507. For example, this can result in undesirable patterning of the elements 201 and their features and in a reduction in smoothness of the lower surface 303 of layer 301. Moreover, in many known methods, in an attempt to pattern the features of the elements 201, excessive pressures are often applied, which impacts the lifetime of the apparatus used to fabricate the layers and creates patterning profiles as well.

Contrastingly, the cushioning or compliance provided by the material 503 provides a substantially even distribution of pressure from the rollers 505 and 506 to the material 502. To wit, and as will become clearer as the present description continues, the material 503 has voids therein. The voids can act somewhat like spring members, giving the material 503 a fluid-like reaction property so that when a force is applied on the material 503 at a normal, the force is distributed more evenly over the material 503 and at the interface between the material 503 and the material 502, and at the interface between the interface between the first material 502 and the roller 505. The former reduces pressure profiles and improves the smoothness of the surface 303; and the latter effects an improvement in the formation of the features, including but not limited to an acceptable land or width 304 of the apex. According to an example embodiment, a significantly reduced pressure compared to known methods is realized. To wit, the nip between the rollers 505 and 506 pressure is beneficially between 1.4×10⁸ dyne-cm and 2.6×10⁸ dyne-cm.

Moreover, in addition to the improvements of reduced pressure provided by the material 503, the material 503 beneficially withstands the higher temperatures of the extrusion process. To this end, the materials useful as the second material 503 illustratively have a glass transition temperature that is relatively high, on the order of approximately 120° C. or greater.

The second material 503, which may be the voided layer 310 and may comprise an air voided polymer layer. Polymer voided layers are beneficial because they have been shown to provide consistent compression, excellent recovery and are low in cost. (“Void” as incorporated herein means devoid of added solid and liquid matter, although it is likely the “voids” contain substances in the gaseous state). The void-initiating particles, which remain in the finished second layer 310, are illustratively from approximately 0.1 μm to approximately 10 μm in diameter and round in shape and can be organic or inorganic, to produce voids of the desired shape and size. The size of the void 308 (as shown in FIG. 3) is also dependent on the degree of orientation (amount the film is stretched after extrusion) in the machine direction (along the direction of the traveling film and transverse (along the width of the film) direction. Ideally, the void would assume a shape that is defined by two opposed and edge contacting concave disks. In other words, the voids 308 tend to have a lens-like or substantially biconvex shape. The voids are oriented so that the two major dimensions are aligned with the machine and transverse directions of the sheet. The Z-direction axis is a minor dimension and is roughly the size of the cross diameter of the voiding particle. The voids generally tend to be closed cells, and thus there is virtually no path open from one side of the voided-core to the other side through which gas or liquid can traverse.

In accordance with certain illustrative embodiments, void-initiating material may be selected from a variety of materials, and should be present in an amount of approximately 5% to approximately 50% by weight based on the weight of the core matrix polymer. Illustratively, the void-initiating material comprises a polymeric material. When a polymeric material is used, it may be a polymer that can be melt-mixed with the polymer from which the core matrix is made and be able to form dispersed spherical particles as the suspension is cooled down. Examples of this would include nylon dispersed in polypropylene, polybutylene terephthalate in polypropylene, or polypropylene dispersed in polyethylene terephthalate. If the polymer is preshaped and blended into the matrix polymer, the important characteristic is the size and shape of the particles. Spheres are useful and they can be hollow or solid. These spheres may be made from cross-linked polymers which are members selected from the group consisting of an alkenyl aromatic compound having the general formula Ar—C(R)═CH₂, wherein Ar represents an aromatic hydrocarbon radical, or an aromatic halohydrocarbon radical of the benzene series and R is hydrogen or the methyl radical; acrylate-type monomers include monomers of the formula CH₂═C(R′)—C(O)(OR) wherein R is selected from the group consisting of hydrogen and an alkyl radical containing from about 1 to 12 carbon atoms and R′ is selected from the group consisting of hydrogen and methyl; copolymers of vinyl chloride and vinylidene chloride, acrylonitrile and vinyl chloride, vinyl bromide, vinyl esters having formula CH₂═CH(O)COR, wherein R is an alkyl radical containing from 2 to 18 carbon atoms; acrylic acid, methacrylic acid, itaconic acid, citraconic acid, maleic acid, fumaric acid, oleic acid, vinylbenzoic acid; the synthetic polyester resins which are prepared by reacting terephthalic acid and dialkyl terephthalics or ester-forming derivatives thereof, with a glycol of the series HO(CH₂)ₙOH wherein n is a whole number within the range of 2-10 and having reactive olefinic linkages within the polymer molecule, the above described polyesters which include copolymerized therein up to 20 percent by weight of a second acid or ester thereof having reactive olefinic unsaturation and mixtures thereof, and a cross-linking agent selected from the group consisting of divinylbenzene, diethylene glycol dimethacrylate, diallyl fumarate, diallyl phthalate and mixtures thereof.

Examples of typical monomers for making the void initiating crosslinked polymer include styrene, butyl acrylate, acrylamide, acrylonitrile, methyl methacrylate, ethylene glycol dimethacrylate, vinyl pyridine, vinyl acetate, methyl acrylate, vinylbenzyl chloride, vinylidene chloride, acrylic acid, divinylbenzene, acrylamidomethyl-propane sulfonic acid, vinyl toluene, etc. Illustratively, the cross-linked polymer is polystyrene or poly(methyl methacrylate); or polystyrene and the cross-linking agent is divinylbenzene.

Processes well known in the art yield non-uniformly sized particles, characterized by broad particle size distributions. The resulting beads can be classified by screening the beads spanning the range of the original distribution of sizes. Other processes such as suspension polymerization, limited coalescence, directly yield very uniformly sized particles.

The void-initiating materials may be coated with agents to facilitate voiding. Suitable agents or lubricants include colloidal silica, colloidal alumina, and metal oxides such as tin oxide and aluminum oxide. The preferred agents are colloidal silica and alumina, or silica. The cross-linked polymer having a coating of an agent may be prepared by procedures well known in the art. For example, a conventional suspension polymerization process wherein the agent is added to the suspension is preferred. As the agent, colloidal silica is preferred.

The void-initiating particles can also be inorganic spheres, including solid or hollow glass spheres, metal or ceramic beads or inorganic particles such as clay, talc, barium sulfate, and calcium carbonate. The important thing is that the material does not chemically react with the core matrix polymer to cause one or more of the following problems: (a) alteration of the crystallization kinetics of the matrix polymer, making it difficult to orient, (b) destruction of the core matrix polymer, (c) destruction of the void-initiating particles, (d) adhesion of the void-initiating particles to the matrix polymer, or (e) generation of undesirable reaction products, such as toxic or high color moieties.

In addition to polymer bead voided polymer sheets, the cushioning layer 310 may be formed by the incorporation of solid particles or non-compatible polymer within the base resin and then oriented in at least one direction. The incorporation of non-compatible polymers or solid inorganic particles has been shown to provide voiding in the compliant layer 310. The cushioning layer may also be formed by chemical or physical blowing agents. Typical material comprises one or more from the list of azodicarbonamide, zeolite or molecular sieves, gases such as nitrogen, carbon dioxide or liquids that turn to gas at atmospheric pressure. Microcellular polymer may be created by saturation of the polymer with a gas such as nitrogen, carbon dioxide or other gas to achieve a bubble density in the range of approximately 0.05 billion/cm³ to 5 billion/cm³.

It is desirable to balance the density of foam to solid phase polymer. Excessive bubble density will alter the mechanical properties of the polymer sheet. Such properties as tensile yield, modulus, compressibility, mechanical stress cracking and others are impacted. Annealing the sheet provides some beneficial impact to the mechanical properties and shrinkage as a result of heating. Advantages to a microcellular foamed sheet or layer when it is coextruded with other solid or filled layers enhances opacity, sharpness, and cushioning of the structure.

The mircocellular foam layer may be coextruded with other solid layers that are either clear or filled with pigment, tinting and optical brightening materials to achieve end optical property. A preferred embodiment would comprise an upper surface of a solid polymer such as a polyolefin. Thickness of said layer may also be varied to achieve the desired optical properties. Directly under this layer is a layer of microcellular foamed polymer. Such a layer may comprises any suitable polymer such as polyolefin and their copolymers, polyester, polystyrene and others that has been super-saturated with a gas such that as it is heated to the optimal temperature that microcellular foam is generated within that polymer layer. This structure may be coextruded directly on the support substrate or may be formed, oriented and annealed as a separate polymer sheet that is then laminated to a support utilizing an adhesive. Such a structure is able to develop good mechanical properties, excellent optical properties as well as having excellent cushioning and compressibility properties.

In an example embodiment, the voided layer 310 is achieved using a chemical blowing agent. A blowing agent is any material, which yields an insoluble gas in a polymer matrix under conditions for extrusion. Two of the preferred blowing agents are azodicarbonamide and sodium bicarbonate. Azodicarbonamide exothermially forms nitrogen and carbon dioxide. The microcellular foam structure is produced by the decomposition of the chemical blowing agent. The gas dissolves in the molten polymer because of the high pressure in the extruder. It is important to optimize the foam nucleation at the point of exiting the die. The drop in pressure causes the gas to become super-saturated. Once the polymer is chilled rapidly the foam bubbles freeze into the polymer as its viscosity increases.

This illustrative technique is sensitive to processing conditions within the extruder as well as the Theological properties of the polymer. The most preferable means is to combine the chemical blowing agent within a polymer in combination with coextrusion of other layers to provide improved mechanical properties, polymer release properties and heat resistance to the top most polymer layer. It may also be necessary to add processing aid to enhance the foaming process as well as the compatibility of the other polymer layers during extrusion. Materials such as antioxidants, slip agents, filler, ultraviolet screening and other may be necessary.

In an example embodiment, the second layer 302 comprises polyester polymer having at least one voided layer. Polyester polymer is preferred because it provides excellent mechanical properties such as mechanical modulus, temperature resistance and scratch resistance compared to polyolefin polymer sheets. Further, it has been shown oriented polyester polymer can be heat set to reduce unwanted shrinkage during the casting of the melted thermoplastic.

Beneficially, and as alluded to previously, the second layer substantially prevents process interactions contributing to thickness differences of thermoplastic cast polymers. Polymer casting process interactions such as roller deflection, die gap profile, polymer melt flow differences, melt curtain temperature differences across a melt curtain. The compliant carrier web provides a spring like surface that can adjust to unwanted process interactions providing a smooth cast polymer surface.

Quantitatively, the compressive load recovery is measured by applying a 1.2 MPa load to the surface of the pliant material for a duration of 60 seconds while the pliant material is at a temperature of 23° C. at 50% relative humidity (RH). The 1.2 MPa load is applied utilizing a circular probe having an area of 0.50 cm². The thickness of the pliant material is measured utilizing a laser micrometer and is measured immediately after removal of the 1.2 MPa load from the surface of the pliant material. The percent recovery is the thickness of the pliant material after the load has been removed divided by the thickness of the pliant material before the load was applied at the measurement conditions of 23 degrees C. and 50% RH.

Through measurements such as these, characteristics of an example compliant carrier sheet include a 25% thickness loss at a load of 1.2 MPa, and a 95% sheet recovery after this load is applied for 60 seconds.

In keeping with illustrative embodiments, the compliant carrier layer 310 has a tensile modulus of approximately 1500 MPa or greater.

Finally, it is noted that the carrier sheet usefully has a surface energy of less than 42 dynes/cm², and even less than 38 dynes/cm² in certain embodiments. This provides release of the compliant layer from the first layer after the extrusion process. Surface energy is measured by contact angle and is an important determining factor for the adhesive strength between the extruded polymer and the carrier sheet.

In accordance with illustrative embodiments, optical films and their methods of manufacture have been described. It is emphasized that the various methods, materials, components and parameters are included by way of example only and not in any limiting sense. Therefore, the embodiments described are illustrative and are useful in providing beneficial backlight assemblies. In view of this disclosure, those skilled in the art can implement the various example devices and methods to effect improved backlight efficiency, while remaining within the scope of the appended claims.

1. A method of fabricating an imaging device, the method comprising:
providing a first layer and a second layer;
extruding the first layer; and
forming a plurality of optical elements over an upper surface of the first layer and a substantially smooth surface on lower surface of the first layer, wherein the second layer comprises a compliant layer having at least one void therein.

2. A method as recited in claim 1, wherein the voids contain a gas.

3. A method as recited in claim 2, wherein the second layer includes a polyester.

4. A method as recited in claim 1, wherein each of the plurality of optical elements has a first side and a second side that are each oriented at approximately 45° relative to the surrounding medium.

5. A method as recited in claim 1, wherein, after the extruding, removing the second layer.

6. A method as recited in claim 1, further comprising a third layer that is substantially smooth disposed between the first and second layers and the third layer is substantially free of voids.

7. A method as recited in claim 6, wherein the third layer is adhered to the second layer.

8. A method as recited in claim 1, wherein the second layer comprises an oriented polyester layer.

9. A method as recited in claim 1, wherein the second layer comprises at least partially crystalline material.

10. A method as recited in claim 1, wherein the extruding further comprises providing a first roller and a second roller and extruding the first layers and providing at least the second layer through the rollers, with the first layer contacting the first roller and the second layer contacting the second roller.

11. A method as recited in claim 10, wherein the first roller comprises a 3-dimensional pattern of a plurality of optical elements.

12. A method as recited in claim 1, wherein each of the plurality of optical elements have an apex having an average width of approximately 0.25 μm to approximately 0.75 μm.

13. A method as recited in claim 12, wherein a standard deviation in the widths of the apexes across the first layer is in the range of approximately ±0.5 μm.

14. A method as recited in claim 1, wherein each of the plurality of optical elements is substantially wedge-shaped.

15. A method as recited in claim 14, wherein the first layer is a light-redirecting layer.

16. A method as recited in claim 1, wherein the imaging device is a liquid crystal display device.

17. A method as recited in claim 1, wherein a surface of the second layer has a surface energy of less than approximately 42.0 dynes/cm².

18. A method as recited in claim 17, wherein the surface has a surface energy of less than approximately 38.0 dynes/cm².

19. A method as recited in claim 1, wherein a surface of the second layer contains high molecular weight siloxane or wax.

20. A method as recited in claim 1, wherein the second layer has a thickness loss of approximately 25% at a load of approximately 1.2 MPa.

21. A method as recited in claim 1, wherein the second layer has a recovery of approximately 95% after application of a load of approximately 1.2 MPa for approximately 60 seconds at a temperature of approximately 180° C.

22. A method as recited in claim 1, wherein the second layer has a thickness of approximately 50 μm to 200 μm.

23. A method as recited in claim 1, wherein the lower surface has an average roughness of approximately 200 nm or less.

24. A method as recited in claim 23, wherein the lower surface has an average roughness in the range of approximately 40 nm to approximately 15 nm.

25. A method as recited in claim 1, wherein the second layer has a glass transition temperature (T_{g}) in the range of approximately 120° C. to 300° C.

26. A method as recited in claim 1, wherein the second layer has an elastic modulus of at least approximately 1500 MPa.

27. A component of an imaging device, comprising:
a first layer including an upper surface over which a plurality of optical elements are disposed and a lower surface that is substantially smooth; and
a second layer over lower surface of the first layer, wherein the second layer comprises a compliant layer having at least one void therein.

28. A component as recited in claim 27, wherein the plurality of optical elements are light redirecting elements.

29. A component as recited in claim 28, wherein the plurality of optical elements has a gain of at least 1.3 in a liquid crystal display device.

30. A component as recited in claim 27, wherein the first and second sides of each said optical elements are each oriented at approximately 45° relative to the surrounding medium.

31. A component as recited in claim 27, wherein an included angle between the first and second sides of each said optical element is approximately 90°.

32. A component as recited in claim 27, wherein the average apex of said optical elements has a width in the range of approximately 0.25 μm to approximately 0.75 μm.

33. A component with optical elements as recited in claim 32, wherein a standard deviation in the widths of the apexes across a layer of the optical component is in the range of approximately ±0.5 μm.

34. A component as recited in claim 27, wherein each of the plurality of optical elements is substantially wedge-shaped.

35. A component as recited in claim 34, wherein at least one side of each optical element has a curvature.

36. A component as recited in claim 27, wherein the first layer comprises a thermoplastic material.

37. A component as recited in claim 27 wherein the lower surface has an average smoothness of approximately 200 nm or less.

38. A component as recited in claim 37, wherein the lower surface has an average smoothness in the range of approximately 40 nm to approximately 15 nm.

39. A component as recited in claim 27, said component further comprising a smoothing layer between the second layer and the first layer.

40. A component as recited in claim 27, wherein the second layer has a glass transition temperature (T_{g}) in the range of approximately 120° C. to 300° C.

41. A component as recited in claim 27, wherein the second layer has an elastic modulus of at least approximately 1500 MPa.
